(19) United States
(12) Patent Application Publication
(10) Pub. No.: US 2015/0050557 A1
(43) Pub. Date: Feb. 19, 2015

(54) NEGATIVE ELECTRODE ACTIVE MATERIAL FOR SODIUM-ION BATTERY AND SODIUM-ION BATTERY

(71) Applicant: Toyota Jidosha Kabushiki Kaisha, Toyota-shi (JP)

(72) Inventor: Hideki Nakayama, Susono-shi (JP)

(21) Appl. No.: 14/457,613

(22) Filed: Aug. 12, 2014

(30) Foreign Application Priority Data
Aug. 13, 2013 (JP) 2013-168140

(51) Int. Cl. H01M 4/485; H01M 10/054

(52) U.S. Cl. CPC H01M 4/485; H01M 10/054; H01M 2004/021
USPC 429/231.1; 428/219

(57) ABSTRACT

A negative electrode active material for a sodium-ion battery includes a Li₄Ti₅O₁₂ phase. A BET specific surface area is equal to or greater than 153 m²/g, and a crystallite size is equal to or smaller than 69 Å.

### INCORPORATION BY REFERENCE

The disclosure of Japanese Patent Application No. 2013-168140 filed on Aug. 13, 2013 including the specification, drawings and abstract is incorporated herein by reference in its entirety.

### BACKGROUND OF THE INVENTION

1. Field of the Invention

The invention relates to a negative electrode active material for a sodium-ion battery, which has good input-output characteristics.

2. Description of Related Art

Sodium-ion batteries are batteries in which sodium ions (Na ions) move between a positive electrode and a negative electrode. Sodium-ion batteries are advantageous in terms of being less costly than lithium (Li)-ion batteries, since Na is more abundant than Li. Ordinarily, a sodium-ion battery includes a positive electrode active material layer that contains a positive electrode active material, a negative electrode active material layer that contains a negative electrode active material, and an electrolyte layer that is disposed between the positive electrode active material layer and the negative electrode active material layer.

Negative electrode active materials used in sodium-ion batteries are the object of intensive research. For instance, Japanese Patent Application Publication No. 2011-049126 (JP 2011-049126 A) discloses the feature of using Li₄Ti₅O₁₂ having a BET specific surface area of 11.8 m²/g, as a negative electrode active material for a sodium-ion battery. Further, Japanese Patent Application Publication No. 2011-181486 (JP 2011-181486 A) illustrates the feature of using a carbon material and Li₄Ti₅O₁₂ as a negative electrode active material for a sodium-ion battery. Further, Zhao Liang et al., “Spinel Lithium titanate (Li₄Ti₅O₁₂) as novel anode material for room-temperature sodium-ion battery”, Chin. Phys. B, Vol. 21, No. 2(2012), 028201 discloses the feature of using Li₄Ti₅O₁₂ as a negative electrode active material for a sodium-ion battery.

As described in JP 2011-049126 A, JP 2011-181486 A and Zhao Liang et al., “Spinel Lithium titanate (Li₄Ti₅O₁₂) as novel anode material for room-temperature sodium ion battery”, Chin. Phys. B, Vol. 21, No. 2(2012), 028201, it is conventionally known that Li₄Ti₅O₁₂ functions as a negative electrode active material for a sodium-ion battery, but there is no report on the input-output characteristics of the negative electrode active material. Meanwhile, the input-output characteristics of sodium-ion batteries that utilize Li₄Ti₅O₁₂ are low.

### SUMMARY OF THE INVENTION

The invention provides a negative electrode active material for a sodium-ion battery, which has good input-output characteristics.

A first aspect of the invention relates to a negative electrode active material for a sodium-ion battery. The negative electrode active material includes a Li₄Ti₅O₁₂ phase. A BET specific surface area is equal to or greater than 153 m²/g, and a crystallite size is equal to or smaller than 69 Å.

According to the first aspect of the invention, it is possible to provide the negative electrode active material for a sodium-ion battery, which has good input-output characteristics, by making the BET specific surface area extremely large or making the crystallite size extremely small.

A second aspect of the invention relates to a sodium-ion battery including a positive electrode active material layer that contains a positive electrode active material; a negative electrode active material layer that contains a negative electrode active material;

and an electrolyte layer disposed between the positive electrode active material layer and the negative electrode active material layer. The negative electrode active material of the sodium-ion battery is the negative electrode active material according to the above-described first aspect of the invention.

According to the second aspect of the invention, it is possible to provide the sodium-ion battery having good input-output characteristics through the use of the negative electrode active material according to the first aspect of the invention.

The negative electrode active material for a sodium-ion battery according to the above aspect has the effect of making it possible to enhance input-output characteristics.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional diagram illustrating an example of a sodium-ion battery of the invention;

FIG. 2 illustrates X-ray diffraction (XRD) measurement results on an active material obtained in a first example;

FIG. 3 illustrates results of a charge and discharge test in a battery for evaluation obtained in the first example; and

FIGS. 4A and 4B illustrate results of a charge and discharge test of batteries for evaluation obtained in first and second examples and first and second comparative examples.

### DETAILED DESCRIPTION OF EMBODIMENTS

A negative electrode active material for a sodium-ion battery and a sodium-ion battery according to the invention will be explained in detail next.

A. Negative electrode active material for a sodium-ion battery

The negative electrode active material for a sodium-ion battery according to the invention will be explained first. The negative electrode active material for a sodium-ion battery according to the invention includes a Li₄Ti₅O₁₂ phase, and has a BET specific surface area equal to or greater than 153 m²/g and a crystallite size equal to or smaller than 69 Å (angstrom).

According to the invention, it is possible to provide a negative electrode active material for a sodium-ion battery, which has good input-output characteristics, by making the BET specific surface area extremely large or making the crystallite size extremely small. For instance, JP 2011-049126 A discloses the feature of using Li₄Ti₅O₁₂ having a BET specific surface area of 11.8 m²/g. Input-output characteristics are however low at such a specific surface area. In contrast, it has been found that input-output characteristics are enhanced in the invention by significantly increasing the BET specific surface area. Ordinarily, BET specific surface area and crystallite size are correlated. That is, the smaller the crystallite size is, the larger the BET specific surface area is.

The reason why the input-output characteristics improve as a result of a significant increase in the BET specific surface area is not necessarily clear, but it is considered that the cause is the increase in the number of reaction sites due to the increase in the reaction surface area.

The negative electrode active material for a sodium-ion battery according to the invention includes a Li₄Ti₅O₁₂ phase. The presence of the Li₄Ti₅O₁₂ phase can be confirmed, for instance, on the basis of XRD measurements.

The proportion of the Li₄Ti₅O₁₂ phase in the negative electrode active material for a sodium-ion battery according to the invention is preferably large.

Specifically, the negative electrode active material for a sodium-ion battery preferably contains the Li₄Ti₅O₁₂ phase as a main constituent. Herein, the feature “Li₄Ti₅O₁₂ phase as a main constituent” signifies that the proportion of the Li₄Ti₅O₁₂ phase is the largest among all the crystalline phases in the negative electrode active material for a sodium-ion battery. The proportion of the Li₄Ti₅O₁₂ phase in the negative electrode active material for a sodium-ion battery is preferably equal to or greater than 50 mol %, more preferably equal to or greater than 60 mol %, and yet more preferably equal to or greater than 70 mol %. The negative electrode active material for a sodium-ion battery according to the invention may include a Li₄Ti₅O₁₂ phase alone (single-phase material). The proportion of the Li₄Ti₅O₁₂ phase in the negative electrode active material for a sodium-ion battery can be determined, for instance, on the basis of quantitative analysis by XRD (for instance, a quantitation method using an R-value, or the Rietveld method).

In the invention, the BET specific surface area of the negative electrode active material for a sodium-ion battery is ordinarily equal to or greater than 153 m²/g, preferably equal to or greater than 160 m²/g. The input-output characteristics may be decreased if the BET specific surface area is excessively small. The BET specific surface area of the negative electrode active material for a sodium-ion battery is, for instance, equal to or smaller than 300 m²/g. The BET specific surface area can be determined according to a nitrogen adsorption method.

In the invention, the crystallite size of the Li₄Ti₅O₁₂ phase is ordinarily equal to or smaller than 69 Π. The input-output characteristics may be decreased if the crystallite size is excessively large. The crystallite size of the Li₄Ti₅O₁₂ phase is, for instance, equal to or greater than 30 A.

The crystallite size of the Li₄Ti₅O₁₂ phase can be calculated on the basis of the half width of a peak obtained in an XRD measurement. For instance, the crystallite size can be determined on the basis of the Scherrer equation using the full width at half maximum (FWHM) of the peak at 2θ=18.3°.

D =Kλ/(βcosθ)

where K: Scherrer constant, λ: wavelength, β: diffraction line broadening by crystallite size, θ: angle of diffraction 2θ/θ

The negative electrode active material for a sodium-ion battery according to the invention is preferably composited with a conductive material, since Na deintercalation capacity can be enhanced as a result. The conductive material that is composited is not particularly limited, as long as it has a desired electron conductivity.

Examples of the conductive material include carbon materials and metal materials, and carbon materials are preferable among the foregoing. Examples of the carbon materials include carbon black such as acetylene black, Ketjen black, furnace black and thermal black; carbon fibers such as vapor grown carbon fibers (VGCFs); carbon nanotubes; graphite; hard carbon; coke and the like. Examples of metal materials include iron (Fe), copper (Cu), nickel (Ni), aluminum (Al) and the like. The feature “the negative electrode active material for a sodium-ion battery and the conductive material are composited” signifies a state ordinarily obtained by subjecting the negative electrode active material for a sodium-ion battery and the conductive material to a mechanochemical treatment. Examples of that state include a state in which both materials are dispersed so as to be in close contact with each other, at the nanometer scale, and a state in which one of the materials is dispersed so as to be in close contact with the surface of the other material, at the nanometer scale. Chemical bonds may exist between the materials. Whether the materials are composited or not can be verified, for instance, by scanning electron microscope (SEM) observation, transmission electron microscope (TEM) observation, TEM-electron energy-loss spectroscopy (EELS) or X-ray absorption fine structure (XAFS). Examples of mechanochemical treatments include treatments that allow imparting mechanical energy, specifically, for instance, ball mills, bead mills, jet mills and the like. A commercially available compositing device (for instance, Nobilta by Hosokawa Micron Corporation) or the like can be used herein.

In a case where the negative electrode active material for a sodium-ion battery is composited with the conductive material, the proportion of the composited conductive material ranges preferably from 1 wt % to 30 wt %, more preferably from 5 wt % to 20 wt %. That is because if the proportion of the composited conductive material is excessively small, the Na deintercalation capacity may not be sufficiently enhanced, whereas if the proportion of the composited conductive material is excessively large, the amount of active material decreases relatively, and capacity may drop. If the composited conductive material is a carbon material, the crystallinity of the carbon material is preferably high. Specifically, the carbon material is preferably composited in such a manner that an interlayer distance d002 or a D/G ratio is a predetermined value, as described below.

Preferably, the negative electrode active material for a sodium-ion battery according to the invention is for instance particulate. The average particle size (D₅₀) of the active material ranges for instance from 1 nm to 100 μm, and preferably from 10 nm to 30 μm.

The method for producing the negative electrode active material for a sodium-ion battery according to the invention is not particularly limited so long as the method allows obtaining the above-described active material. Examples of the method include a solid phase method, a sol-gel method, a spray drying method, a spray pyrolysis method, a hydrothermal method and a co-precipitation method. Methods for adjusting the BET specific surface area and the crystallite size include selection of starting material compounds, selection of synthesis conditions, and selection of the conditions under which the synthesized active material is mixed.

B. Sodium-ion Battery

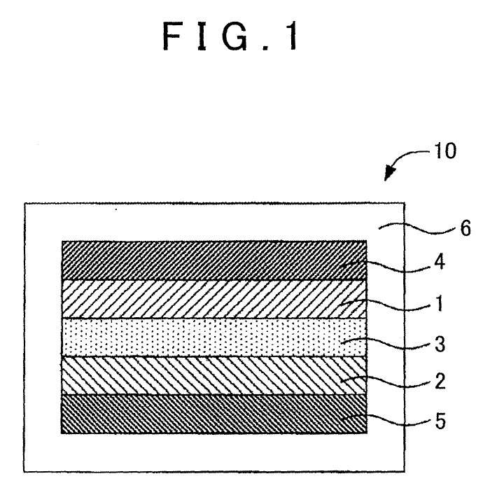

FIG. 1 is a schematic sectional diagram illustrating an example of the sodium-ion battery according to the invention. A sodium-ion battery 10 illustrated in FIG. 1 includes a positive electrode active material layer 1, a negative electrode active material layer 2, an electrolyte layer 3 that is disposed between the positive electrode active material layer 1 and the negative electrode active material layer 2, a positive electrode collector 4 that collects current of the positive electrode active material layer 1, a negative electrode collector 5 that collects current of the negative electrode active material layer 2, and a battery case 6 that accommodates the foregoing members. The negative electrode active material layer 2 contains the negative electrode active material described in section “A. Negative electrode active material for a sodium-ion battery” above.

According to the invention, it is possible to provide the sodium-ion battery having good input-output characteristics through the use of the above-described negative electrode active material for a sodium-ion battery. The configuration of the sodium-ion battery according to the invention will be explained next.

1. Negative Electrode Active Material Layer

The negative electrode active material layer according to the invention will be explained first. The negative electrode active material layer according to the invention contains at least a negative electrode active material. The negative electrode active material layer may contain, in addition to the negative electrode active material, at least one from among a conductive material, a binder and a solid electrolyte material.

The negative electrode active material according to the invention is ordinarily the negative electrode active material described in “A. Negative electrode active material for a sodium-ion battery” above.

The negative electrode active material layer according to the invention preferably contains a conductive material. The conductive material may be a conductive material that is composited with the negative electrode active material, or may be a material that is present, in the negative electrode active material layer, in a state of being not composited but mixed with the negative electrode active material, or may be both.

The conductive material is not particularly limited, so long as it has a desired electron conductivity, and the particulars of the conductive material may be identical to those described in “A. Negative electrode active material for a sodium-ion battery” above. Among the foregoing, the conductive material is preferably a carbon material. Particularly preferably, the carbon material has high crystallinity. That is because Na ions are intercalated into the carbon material less readily, and the irreversible capacity due to Na ion intercalation can be reduced, when the crystallinity of the carbon material is high. The charge and discharge efficiency can be enhanced as a result. The crystallinity of the carbon material can be specified, for instance, by the interlayer distance d002 and the D/G ratio.

The interlayer distance d002 of the carbon material is preferably, for instance, equal to or smaller than 3.5 Å, more preferably equal to or smaller than 3.4 Å, since a highly crystalline carbon material can be obtained as a result. The interlayer distance d002 is generally equal to or greater than 3.36 Å. The interlayer distance d002 signifies the interplanar spacing between (002) planes in the carbon material, and specifically corresponds to the distance between graphene layers. The interlayer distance d002 can be determined for instance on the basis of peaks obtained by XRD using CuKα rays.

The D/G ratio of the carbon material obtained on the basis of Raman spectrometry is preferably, for instance, equal to or smaller than 0.8, more preferably equal to or smaller than 0.7 and yet more preferably equal to or smaller than 0.5, since a highly crystalline carbon material can be obtained as a result. The DIG ratio signifies herein the intensity of a D-band peak due to a defect structure, in the vicinity of 1350 cm⁻¹, with respect to the intensity of a G-band peak due to a graphite structure, in the vicinity of 1590 cm⁻¹, the D/G ratio being determined by Raman spectrometry (wavelength 532 nm).

The binder is not particularly limited, so long as it is chemically and electrically stable. Examples of the binder include fluorine-based binders such as polyvinylidene fluoride (PVDF) and polytetrafluoroethylene (PTFE), rubber-based binders such as styrene-butadiene rubber, imide-based binders such as polyimide, olefin-based binders such as polypropylene (PP) and polyethylene (PE), and cellulose-based binders such as carboxymethyl cellulose (CMC). The solid electrolyte material is not particularly limited so long as it has a desired ion conductivity. Examples of the solid electrolyte material include oxide solid electrolyte materials and sulfide solid electrolyte materials.

The solid electrolyte material will be explained in detail in the section “3. Electrolyte layer” below.

The content of the negative electrode active material in the negative electrode active material layer is preferably larger, in terms of capacity; for instance, the content ranges preferably from 60 wt % to 99 wt %, and particularly preferably from 70 wt % to 95 wt %. The content of the conductive material is preferably smaller, so long as the desired electron conductivity can be secured, and ranges for instance from 5 wt % to 80 wt %, and preferably from 10 wt % to 40 wt %. That is because if the content of conductive material is excessively small, sufficient electron conductivity may not be achieved, whereas if the content of the conductive material is excessively large, the amount of active material decreases relatively, and capacity may drop. The content of the binder is preferably smaller, so long as the negative electrode active material and so forth can be fixed stably, and the content of the binder ranges preferably, for instance, from 1 wt % to 40 wt %. That is because if the content of the binder is excessively small, sufficient binding properties may not be achieved, whereas if the content of the binder is excessively large, the amount of active material decreases relatively, and capacity may drop. The content of the solid electrolyte material is preferably smaller, so long as the desired ion conductivity can be secured, and the content of the solid electrolyte material ranges preferably, for instance, from 1 wt % to 40 wt %. That is because if the content of the solid electrolyte material is excessively small, sufficient ion conductivity may not be achieved, whereas if the content of the solid electrolyte material is excessively large, the amount of active material decreases relatively, and capacity may drop.

The thickness of the negative electrode active material layer varies significantly depending on the configuration of the battery, and ranges preferably, for instance, from 0.1 μm to 1000 μm.

2. Positive electrode active material layer

The positive electrode active material layer according to the invention will be explained next. The positive electrode active material layer according to the invention contains at least a positive electrode active material. The positive electrode active material layer may contain, in addition to the positive electrode active material, at least one from among a conductive material, a binder and a solid electrolyte material.

Examples of the positive electrode active material include layered active materials, spinel-type active materials and olivine-type active materials. Specific examples of the positive electrode active material include NaFeO₂, NaNiO₂, NaCoO₂, NaMnO₂, NaVO₂, Na(NiₓMn₁₋ₓ)O₂(0<X<1), Na(FeₓMn₁₋ₓ)O₂(0<X<1), NaVPO₄F, Na₂FePO₄F, Na₃V₂(PO₄)₃ and the like.

Preferably, the positive electrode active material is particulate. The average particle size (D₅₀) of the positive electrode active material ranges, for instance, from 1 nm to 100 μm, and preferably from 10 nm to 30 μm. The content of the positive electrode active material in the positive electrode active material layer is preferably larger, in terms of capacity; for instance, the content ranges preferably from 60 wt % to 99 wt %, and particularly preferably from 70 wt % to 95 wt %. The types and contents of the conductive material, binder and solid electrolyte material that are used in the positive electrode active material layer are identical to those of the negative electrode active material layer described above, and hence will not be explained again herein. The thickness of the positive electrode active material layer varies significantly depending on the configuration of the battery, and ranges preferably, for instance, from 0.1 μm to 1000 μm.

3. Electrolyte Layer

The electrolyte layer according to the invention will be explained next. The electrolyte layer according to the invention is disposed between the positive electrode active material layer and the negative electrode active material layer. Conduction of ions between the positive electrode active material and the negative electrode active material takes place via the electrolyte in the electrolyte layer. The form of the electrolyte layer is not particularly limited, and examples thereof include a liquid electrolyte layer, a gel electrolyte layer, a solid electrolyte layer and the like.

The liquid electrolyte layer is a layer ordinarily obtained using a nonaqueous electrolyte solution. The nonaqueous electrolyte solution contains ordinarily a sodium salt and a nonaqueous solvent. Examples of the sodium salt include inorganic sodium salts such as NaPF₆, NaBF₄, NaClO₄ and NaAsF₆, and organic sodium salts such as NaCF₃SO₃, NaN(CF₃SO₂)₂, NaN(C₂F₅SO₂)₂, NaN(FSO₂)₂ and NaC(CF₃SO₂)₃.

The nonaqueous solvent is not particularly limited so long as it dissolves the sodium salt. Examples of high-dielectric-constant solvents include cyclic esters (cyclic carbonates) such as ethylene carbonate (EC), propylene carbonate (PC) and butylene carbonate (BC); and y-butyrolactone, sulfolane, N-methyl pyrrolidone (NMP), 1,3-dimethyl-2-imidazolidinone (DMI) and the like. Low-viscosity solvents include chain esters (chain carbonates) such as dimethyl carbonate (DMC), diethyl carbonate (DEC) and ethyl methyl carbonate (EMC), acetates such as methyl acetate and ethyl acetate, and ethers such as 2-methyl tetrahydrofuran. A mixed solvent resulting from mixing a high-dielectric-constant solvent and a low-viscosity solvent may be used herein.

The concentration of the sodium salt in the nonaqueous electrolyte solution ranges for instance from 0.3 mol/L to 5 mol/L, preferably from 0.8 mol/L to 1.5 mol/L. That is because if the concentration of sodium salt is excessively low, high-rate capacity may decrease, whereas if the concentration of the sodium salt is excessively high, viscosity increases, and low-temperature capacity may decrease. For instance, a low-volatile liquid such as an ionic liquid may be used as the nonaqueous electrolyte solution.

The gel electrolyte layer can be obtained, for instance, through gelling of a nonaqueous electrolyte solution by adding a polymer thereto. Specifically, gelling can be accomplished by adding, to a nonaqueous electrolyte solution, a polymer such as polyethylene oxide (PEO), polyacrylonitrile (PAN) or polymethyl methacrylate (PMMA).

The solid electrolyte layer is a layer obtained by using the solid electrolyte material. The solid electrolyte material is not particularly limited so long as it has a desired Na ion conductivity, but examples thereof include oxide solid electrolyte materials and sulfide solid electrolyte materials. Examples of oxide solid electrolyte materials include Na₃Zr₂Si₂PO₁₂, β alumina solid electrolytes (for example Na₂O-11Al₂O₃) and the like. Examples of sulfide solid electrolyte materials include Na₂S-P₂S₅ and the like.

The solid electrolyte material may be amorphous or crystalline. Preferably, the solid electrolyte material is particulate. The average particle size (D₅₀) of the solid electrolyte material ranges, for instance, from 1 nm to 100 μm, and preferably from 10 nm to 30 μm.

The thickness of the electrolyte layer varies significantly depending on the type of the electrolyte and on the configuration of the battery, but ranges for instance from 0.1 μm to 1000 μm, and preferably from 0.1 μm to 300 μm.

4. Other features

The sodium-ion battery according to the invention includes at least the above-described negative electrode active material layer, positive electrode active material layer and electrolyte layer. Ordinarily, the sodium-ion battery further includes a positive electrode collector that collects current of the positive electrode active material layer and a negative electrode collector that collects current of the negative electrode active material layer. Examples of the material of the positive electrode collector include stainless steel (SUS), aluminum (Al), nickel (Ni), iron (Fe), titanium, carbon and the like. Examples of the material of the negative electrode collector include stainless steel (SUS), copper (Cu), nickel (Ni), carbon and the like. The collector may be, for instance, in the form of a foil or a mesh, or may be porous. The method of forming the active material layers on the collectors is not particularly limited, and may be, for instance, a doctor-blade method, an electrostatic coating method, a dip coating method, a spray coating method or the like.

The sodium-ion battery according to the invention may include a separator between the positive electrode active material layer and the negative electrode active material layer, since a battery that has higher safety can be obtained in such a case. The material of the separator may be an organic material or an inorganic material. Specific examples of the material of the separator include porous membranes of polyethylene (PE), polypropylene (PP), cellulose or polyvinylidene fluoride (PVDF) and nonwoven fabrics such as resin nonwoven fabrics and glass-fiber nonwoven fabrics. The separator may have single-layer structure (for instance, of PE or PP) or a multilayer structure (for instance, PP/PE/PP). The battery case of an ordinary battery can be used herein as the battery case. Examples of battery cases include battery cases made of SUS.

5. Sodium-ion Battery

The sodium-ion battery according to the invention is not particularly limited so long as the battery includes the above-described positive electrode active material layer, negative electrode active material layer and electrolyte layer. The sodium-ion battery according to the invention may be a battery in which the electrolyte layer is a solid electrolyte layer, a battery in which the electrolyte layer is a liquid electrolyte layer, or a battery in which the electrolyte layer is a gel electrolyte layer. Further, the sodium-ion battery according to the invention may be a primary battery or a secondary battery, but is preferably a secondary battery among the foregoing, since a secondary battery can be charged and discharged repeatedly, and is thus useful for instance as an in-vehicle battery. The shape of the sodium-ion battery according to the invention may be, for instance, a coin shape, a laminate shape, a cylindrical shape or a square or rectangular shape. The method of producing the sodium-ion battery is not particularly limited, and may be the same as a production method for an ordinary sodium-ion battery.

The invention is not limited to the above embodiments. The foregoing embodiments are merely illustrative, and thus the technical scope of the invention encompasses any configuration that involves substantially the same features as those of the technical idea according to the invention and set forth in the claims, and that elicits substantially the same effect as that technical idea.

The invention will be explained more specifically based on the examples below.

(First comparative example) Herein Ti[(CH₃)₂CHO]₄(titanium (IV) isopropoxide) was used as a Ti source and Li(CH₃COO)·2H₂O was used as a Li source. These materials were stirred at 80° C., for 24 hours in an aqueous solution whose pH had been adjusted to 1.5 or less using nitric acid. Thereafter, pre-baking was performed in an air atmosphere at 200° C. for 5 hours. The resulting product was then crushed, and baking was performed in an air atmosphere at 800° C., for 10 hours, to yield Li₄Ti₅O₁₂ (LTO) as a result. Thereafter, the obtained LTO was subjected to a ball mill treatment (using ZrO₂ balls, at revolutions of 180 revolutions per minute (rpm), for 24 hours), to yield an active material.

(Second comparative example) An active material was obtained in the same manner as in the first comparative example, except that the revolutions in the ball mill treatment were modified to 240 rpm.

(First example) Herein, Ti[(CH₃)₂CHO]₄ (titanium (IV) isopropoxide) was used as the Ti source, and an ethanol solution of metallic Li as the Li source. The foregoing materials were added to pure water, and polyethylene glycol was further added thereto, with stirring. After ultrasonic treatment was performed, baking was performed in an air atmosphere, at 500° C., for 30 minutes. As a result there was obtained an active material having a Li₄Ti₅O₁₂ (LTO) composition.

(Second example) An active material was obtained in the same manner as in the first example, except that Ti(OCH₂CH₂CH₂CH₃₎₄ (titanium (IV) n-butoxide) was used as the Ti source.

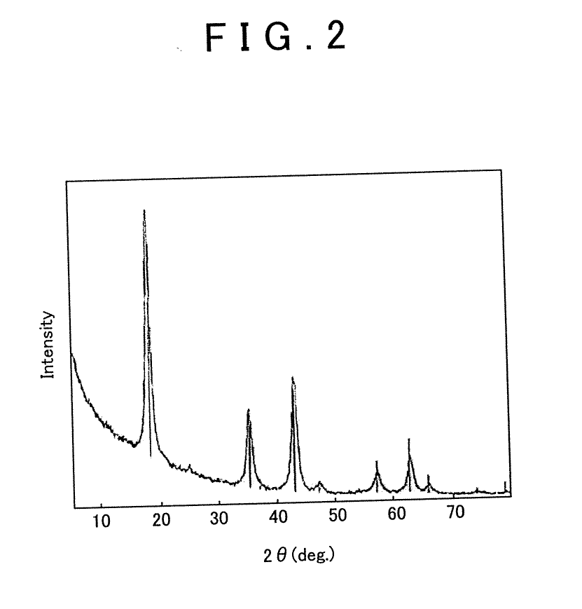

(Evaluation) (XRD measurement) The active materials obtained in the first and second examples and the first and second comparative examples were measured by XRD using CuKα rays. The results revealed that the LTO was obtained in all of the first and second examples and the first and second comparative examples. For reference, FIG. 2 illustrates XRD measurement results on the active material obtained in the first example. The crystallite size was calculated using the above-described Scherrer equation, on the basis of the full width at half maximum (FWHM) of the peak at 2θ=18.3°. The results are shown in Table 1.

(BET measurement) The BET specific surface area of the active materials obtained in each of the first and second examples and the first and second comparative examples was determined in accordance with a nitrogen adsorption method using an instrument TriStar 3000, by Shimadzu Corporation. The results are shown in Table 1.

(Input-output characteristic evaluation) Batteries for evaluation were produced using the active materials obtained in the first and second examples and the first and second comparative examples. Firstly, each of the obtained active materials, a conductive material (acetylene black, interlayer distance d002=3.54 Å, D/G ratio=0.87) and a binder (polyvinylidene fluoride (PVDF)) were weighed, at a weight ratio of active material:conductive material:binder=85:10:5, and were kneaded, to yield a paste. Next, the obtained paste was applied onto a copper foil, using a doctor blade, and the copper foil with the paste was dried and pressed, to yield a 20 μm-thick test electrode.

Thereafter, a CR2032-type coin cell was used, the above test electrode was used as a working electrode, metallic Na was used as a counter electrode, and a porous separator of polyethylene/polypropylene/polyethylene (PE/PP/PE) (thickness 25 μm) was used as a separator. A solution, which was obtained by dissolving NaPF₆, at a concentration of 1 mol/L, in a mixed solvent of equal volumes of ethylene carbonate (EC) and diethyl carbonate (DEC), was used as the electrolyte solution.

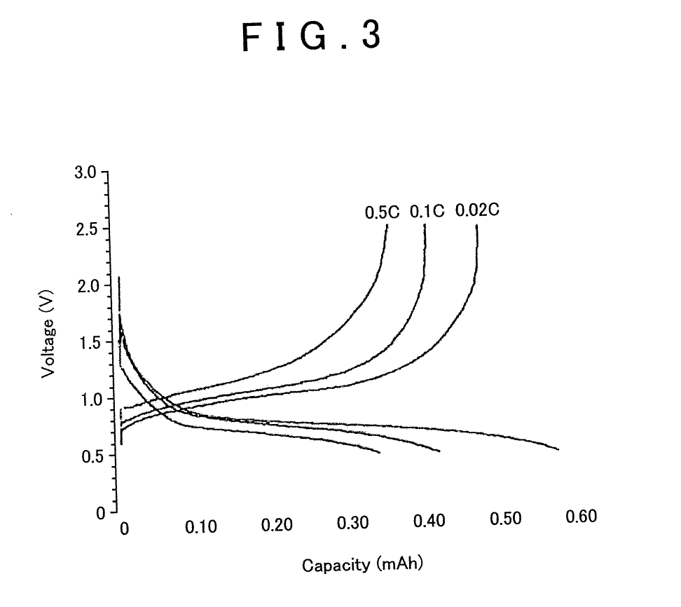

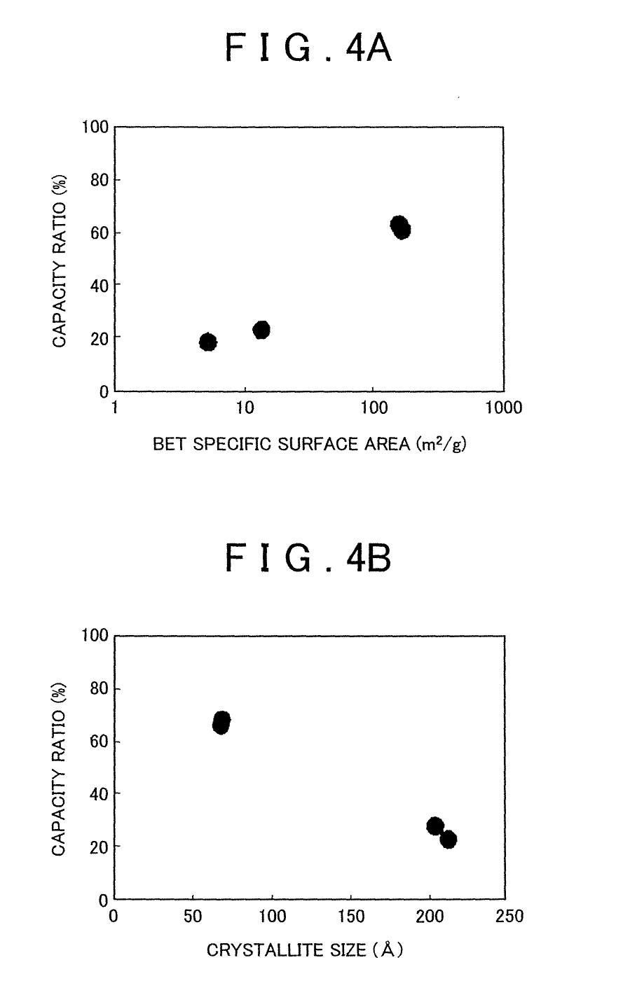

Next, the obtained battery for evaluation was subjected to a charge and discharge test while changing a charge and discharge current value, to evaluate the input-output characteristics. Specifically, a ratio of the reversible capacity (Na deintercalation capacity) when charge and discharge (voltage range 0.5 V to 2.5 V) were performed at an environmental temperature of 25° C. and at a current value of 3 mA/g (0.02 C), and the reversible capacity (Na deintercalation capacity) when charge and discharge were performed in a similar manner at a current value of 75 mA/g (0.5 C) was calculated herein as the capacity ratio (0.5 C/0.02 C). The results are illustrated in FIG. 3, FIGS. 4A and 4B and Table 1.

TABLE 1

| | BET specific | | |
|---|---|---|---|
| | surface area | Crystallite size | Capacity ratio |
| | (m²/g) | (Å) | (%) |
| First | 5.2 | 212 | 21 |
| comparative | | | |
| example | | | |
| Second | 13.5 | 204 | 26 |
| comparative | | | |
| example | | | |
| First example | 153 | 69 | 67 |
| Second example | 160 | 68 | 65 |

As shown in FIG. 3, FIGS. 4A and 4B and Table 1, the capacity ratio, i.e. the input-output characteristics, is dramatically enhanced by making the BET specific surface area extremely large or making the crystallite size extremely small.

What is claimed is:

1. A negative electrode active material for a sodium-ion battery, comprising:
a Li₄Ti₅O₁₂ phase, wherein
a BET specific surface area is equal to or greater than 153 m²/g, and
a crystallite size is equal to or smaller than 69 Å.

2. The negative electrode active material according to claim 1, wherein
the BET specific surface area is equal to or smaller than 300 m²/g.

3. A sodium-ion battery comprising:
a positive electrode active material layer that contains a positive electrode active material;
a negative electrode active material layer that contains a negative electrode active material; and
an electrolyte layer disposed between the positive electrode active material layer and the negative electrode active material layer, wherein
the negative electrode active material of the sodium-ion battery is the negative electrode active material according to claim 1.

4. The sodium-ion battery according to claim 3, wherein
a content of the negative electrode active material in the negative electrode active material layer ranges from 60 wt % to 99 wt %.

5. The sodium-ion battery according to claim 4, wherein
the content of the negative electrode active material in the negative electrode active material layer ranges from 70 wt % to 95 wt %.
